(19) United States
(12) Patent Application Publication
(10) Pub. No.: US 2011/0286230 A1
(43) Pub. Date: Nov. 24, 2011

(54) HEADLAMP

(75) Inventor: Ching-Yu HUANG, Fontana, CA (US)

(73) Assignee: MAXZONE AUTO PARTS CORP., Fontana, CA (US)

(21) Appl. No.: 12/854,902

(22) Filed: Aug. 12, 2010

(30) Foreign Application Priority Data
May 21, 2010 (TW) 99209680

(51) Int. Cl. B60Q 1/04

(52) U.S. Cl. 362/539

(57) ABSTRACT

A headlamp is disclosed. The headlamp includes a light source, a plurality of light shades, at least one linear guide, and at least one cam. The light source emits at least one light beam. The linear guide directs the linear motions of the light shades relative to the light source. The cam moves at least one of the light shades to shade at least one part of the light beam.

### RELATED APPLICATIONS

The application claims priority to Taiwan Application Serial Number 99209680, filed May 21, 2010, which is herein incorporated by reference.

### BACKGROUND

1. Technical Field

The present disclosure relates to a car illuminator. More particularly, the present disclosure relates to a headlamp.

2. Description of Related Art

The head lamp is attached to the front of a car for illuminating a light beam. Some headlamps have a light shade, and the light shade provides the cutoff for the light beam to change the shape of the light beam. Furthermore, the light shades having different shape make the light beam having different shape. However, the headlamp does not have a satisfying device to drive the light shades.

### SUMMARY

According to one embodiment of the present disclosure, a headlamp includes a light source, a plurality of light shades, at least one linear guide, and at least one cam. The light source emits at least one light beam. The linear guide directs the linear motions of the light shades relative to the light source. The cam moves at least one of the light shades to shade at least one part of the light beam.

According to another embodiment of the present disclosure, a headlamp includes a reflector, a light source, a plurality of light shades, at least one linear guide, an actuator, and a parallel indexing cam. The light source is disposed in the reflector to emit at least one light beam. Each of the light shades includes a follower part. The linear guide moveably couples the light shades to the reflector. The parallel indexing cam is connected to the actuator. The parallel indexing cam includes a plurality of lobes for pushing at least one of the follower parts of the light shades to shade at least one part of the light beam.

### BRIEF DESCRIPTION OF THE DRAWINGS

FIG. 1 is a three-dimensional view of a headlamp according to one embodiment of the present disclosure.

FIG. 2 is an exploded view of the headlamp of FIG. 1.

FIG. 3 is a front view of the headlamp of FIG. 1.

FIG. 4 is a side view of the headlamp of FIG. 1.

FIG. 5 is a front view of the headlamp of FIG. 1, showing that the cam pushes one light shade.

FIG. 6 is a side view of the headlamp of FIG. 1, showing that the cam pushes one light shade.

FIG. 7 is a front view of the headlamp of FIG. 1, showing that the cam pushes another light shade.

FIG. 8 is a side view of the headlamp of FIG. 1, showing that the cam pushes another light shade.

FIG. 9 is a front view of the headlamp of FIG. 1, showing that the cam pushes yet another light shade.

FIG. 10 is a side view of the headlamp of FIG. 1, showing that the cam pushes yet another light shade.

FIG. 11 is a three-dimensional view of a headlamp according to another embodiment of the present disclosure.

FIG. 12 is a three-dimensional view of a headlamp according to yet another embodiment of the present disclosure.

FIG. 13 is a three-dimensional view of a headlamp according to yet another embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

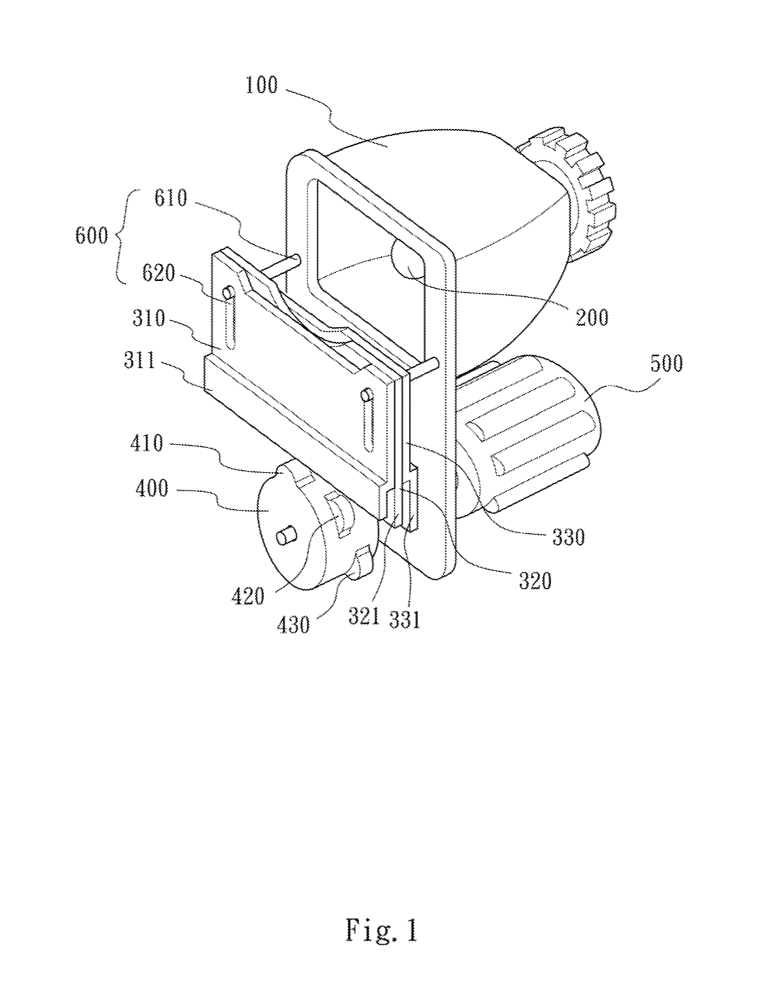

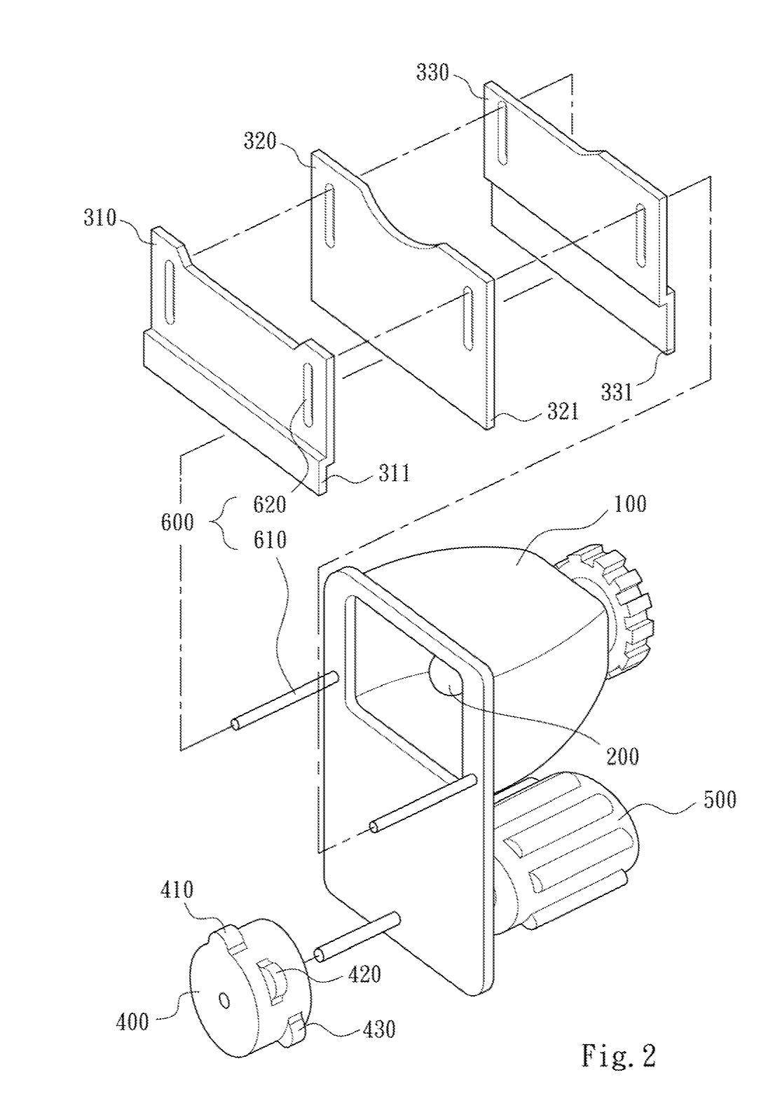

FIG. 1 is a three-dimensional view of a headlamp according to one embodiment of the present disclosure. FIG. 2 is an exploded view of the headlamp of FIG. 1. The headlamp includes a reflector 100, a light source 200, a plurality of light shades 310, 320, 330, at least one linear guide 600, an actuator 500, and at least one cam 400. The light source 200 is disposed in the reflector 100 to emit at least one light beam. The light shades 310, 320, 330 include a follower part 311, 321, 331. The linear guide 600 moveably couples the light shades 310, 320, 330 to the reflector 100 for directing the linear motion of the light shades 310, 320, 330 relative to the light source 200. The cam 400 is connected to the actuator 500. The cam 400 includes a plurality of lobes 410, 420, 430 for pushing at least one of the follower parts 311, 321, 331 of the light shades 310, 320, 330 to shade at least one part of the light beam.

The linear guide 600 includes a pin 610 and a plurality of grooves 620. The pin 610 is disposed on the reflector 100. The grooves 620 are linear and disposed in the light shades 310, 320, 330 respectively. The pin 610 is slidably received in the grooves 620.

The number of the linear guide 600 is two. The two linear guides 600 are disposed on two sides of the light shades 310, 320, 330. The light shades 310, 320, 330 can move steady by the linear guides 600 when the cam 400 pushes the light shades 310, 320, 330.

The cam 400 is a parallel indexing cam. The number of the lobes 410, 420, 430 is three. The term “parallel indexing cam” means that the cam 400 has a plurality of lobes 410, 420, 430, and the protruding direction of the lobes 410, 420, 430 are different. In detail, there are at least two kinds of the cam 400. Regarding one kind of the cam 400, the lobes 410, 420, 430 have different position by radial vision and different angle by axial vision. This embodiment is this kind of the cam 400. Furthermore, regarding another kind of the cam 400, the lobes 410, 420, 430 have different angle by axial vision and different thickness by radial vision.

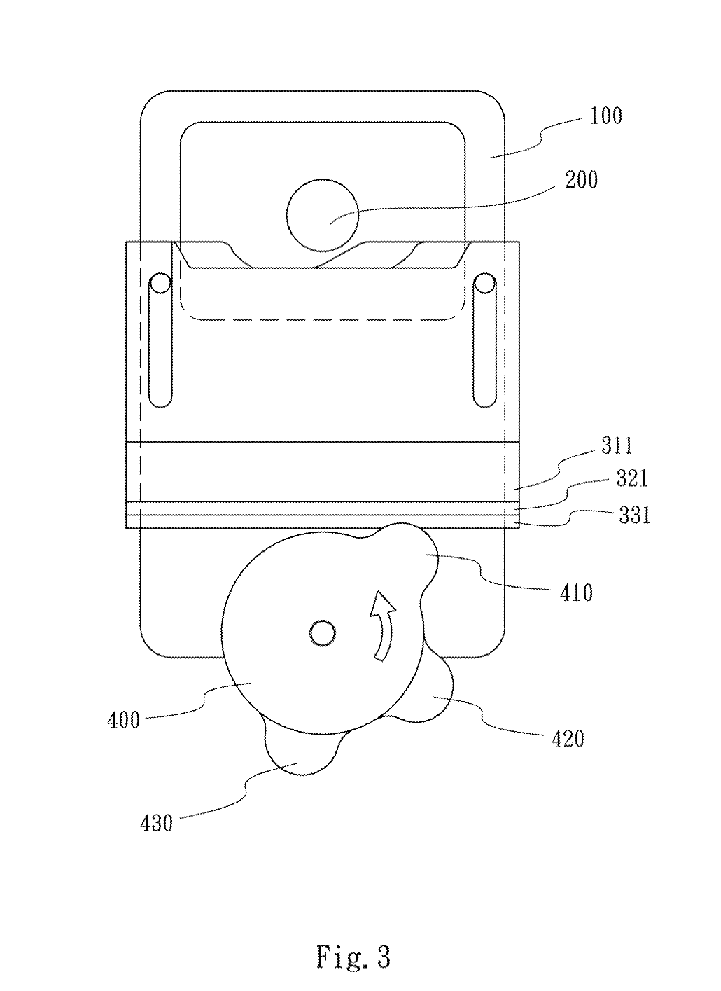

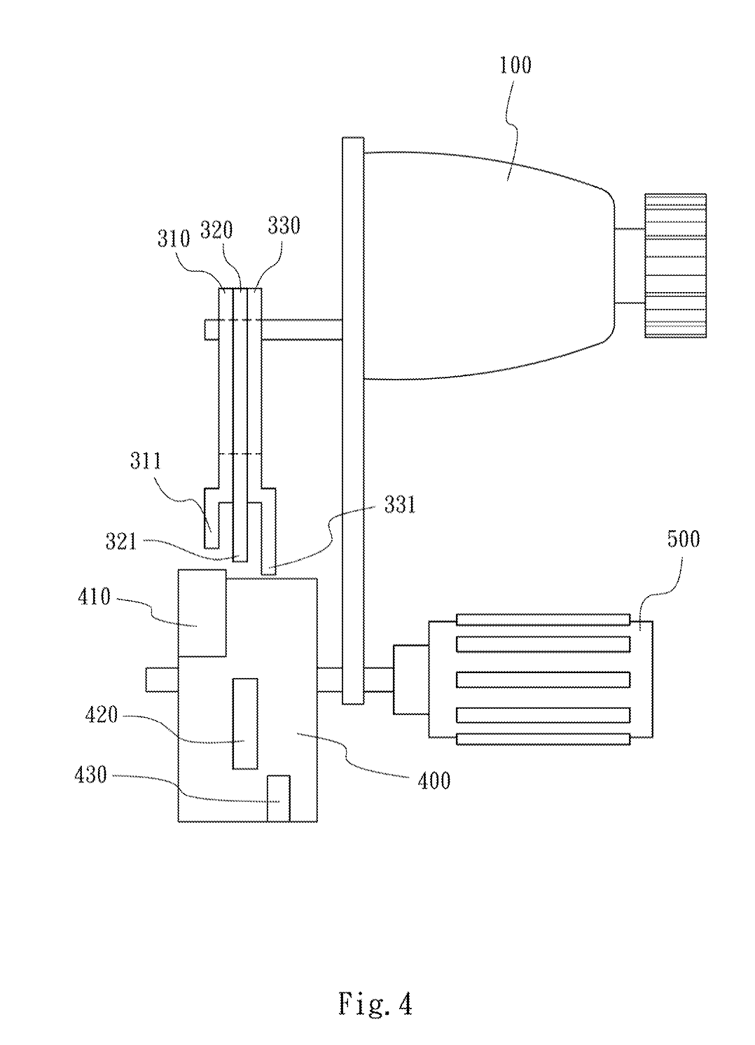

FIG. 3 is a front view of the headlamp of FIG. 1. FIG. 4 is a side view of the headlamp of FIG. 1. The cam 400 is under the light shades 310, 320, 330. The number of the light shades 310, 320, 330 is three. The distance between the follower parts 311, 321, 331 and the lobes 410, 420, 430 are different. In detail, the distance between the follower part 331 and the lobe 430 is the smallest, and the distance between the follower part 311 and the lobe 410 is the largest. Furthermore, the follower parts 311, 321, 331 are positioned on the rotating path of lobes 410, 420, 430.

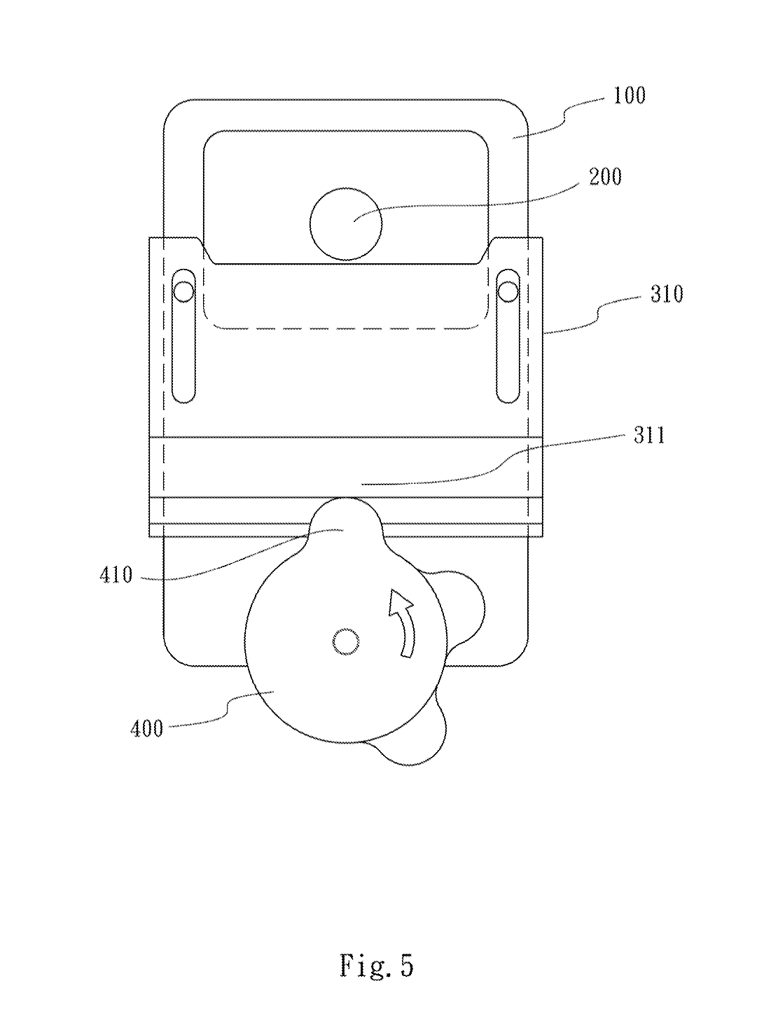

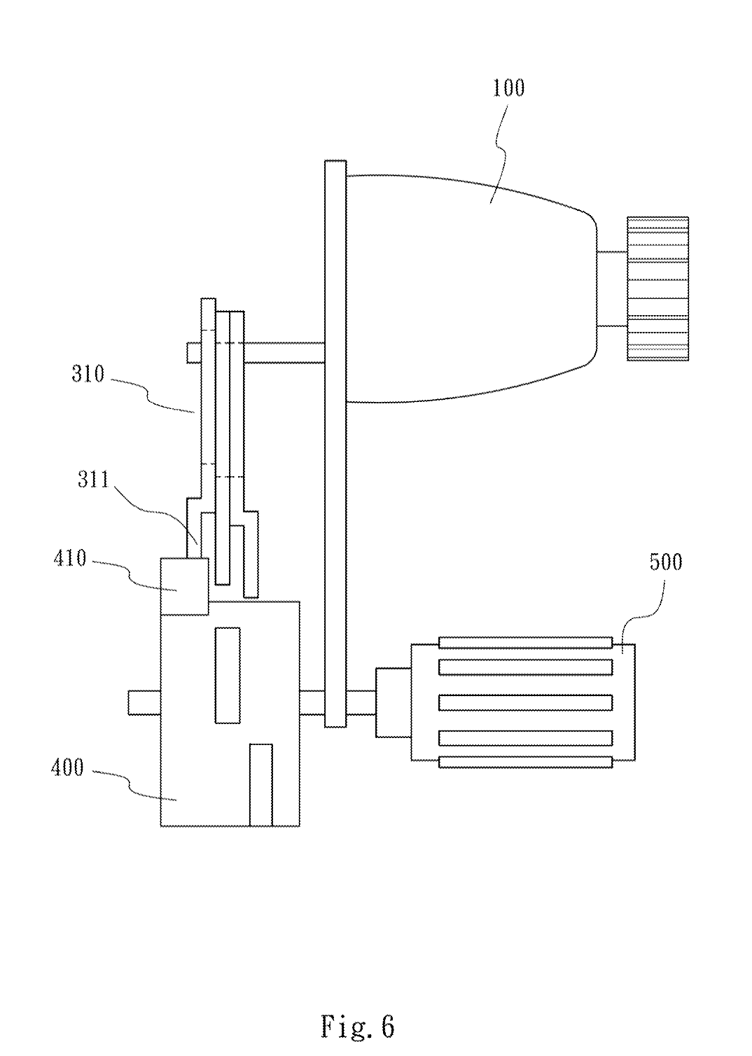

FIG. 5 is a front view of the headlamp of FIG. 1, showing that the cam 400 pushes one light shade 310. FIG. 6 is a side view of the headlamp of FIG. 1, showing that the cam 400 pushes one light shade 310. The actuator 500 drives the cam 400 to rotate. The lobe 410 is rotated and pushes the follower part 311 to move the light shade 310. The light shade 310 moves upwardly and shades at least one part of the light beam for changing the shape of the light beam.

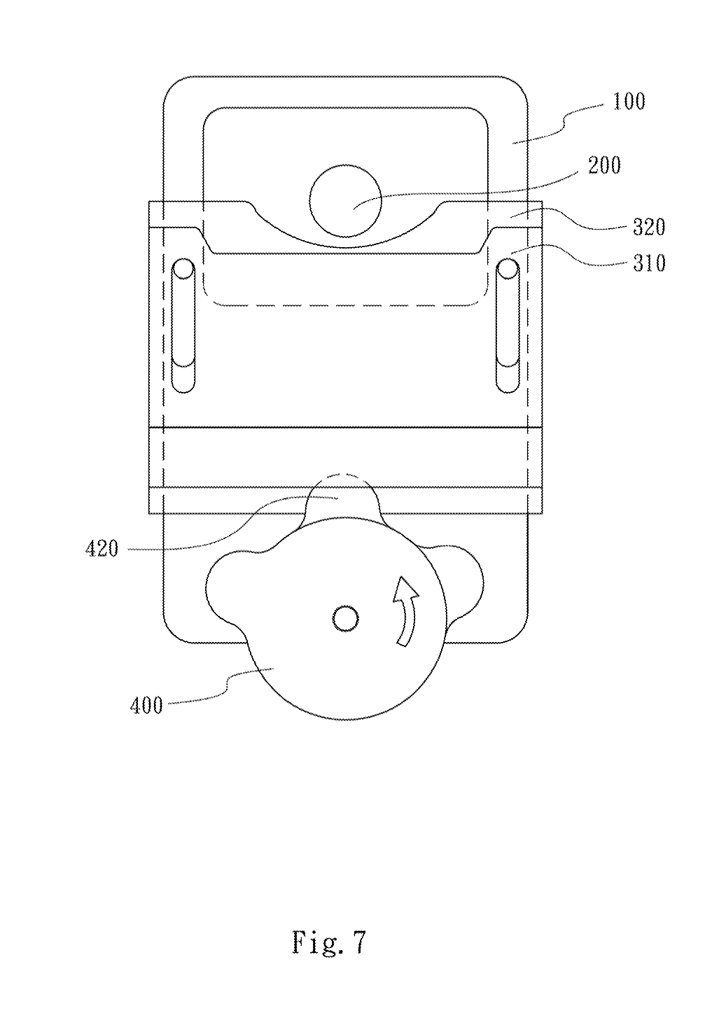

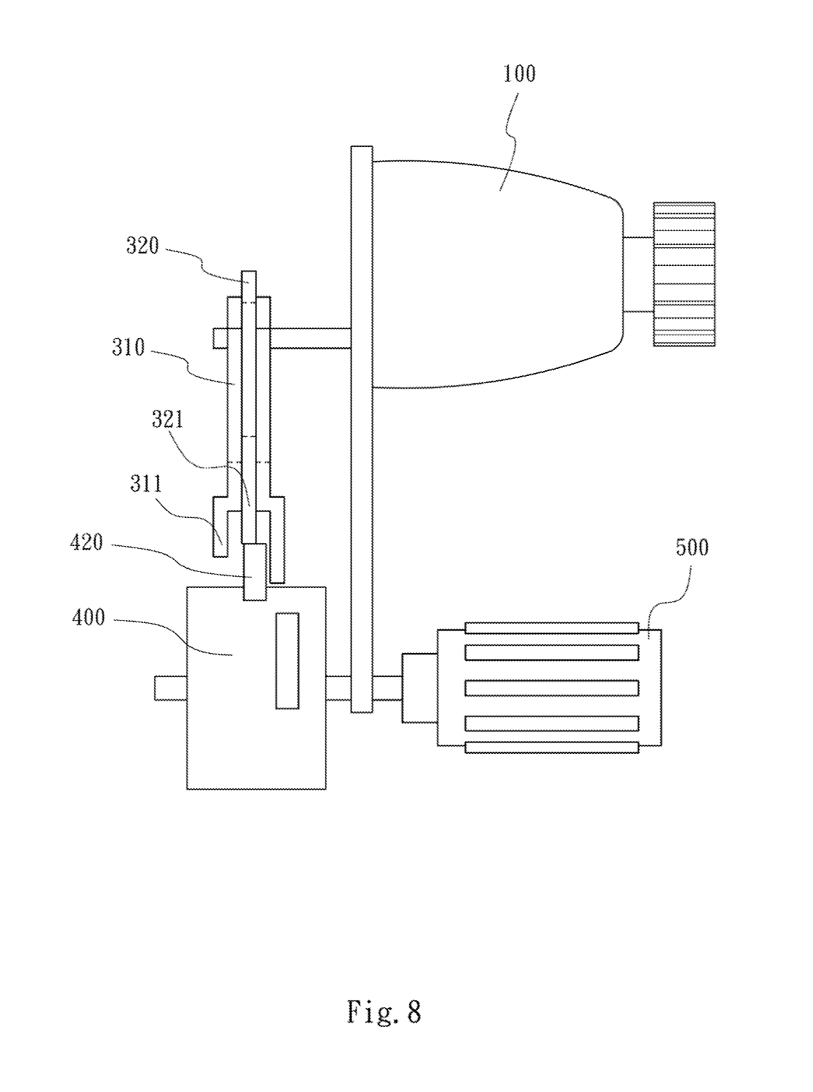

FIG. 7 is a front view of the headlamp of FIG. 1, showing that the cam 400 pushes another light shade 320. FIG. 8 is a side view of the headlamp of FIG. 1, showing that the cam 400 pushes another light shade 320. The lobe 420 pushes the follower part 321 to move the light shade 320, after the lobe 410 is removed and the light shade 310 falls. Therefore, the light shade 320 can produce another shape of the light beam.

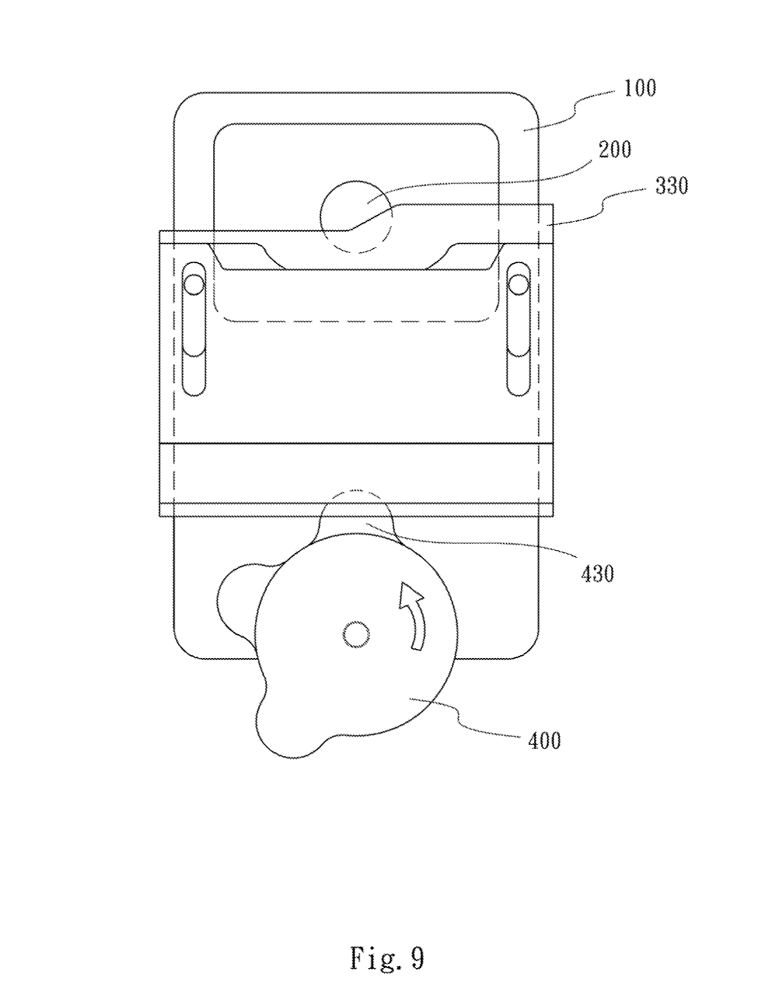

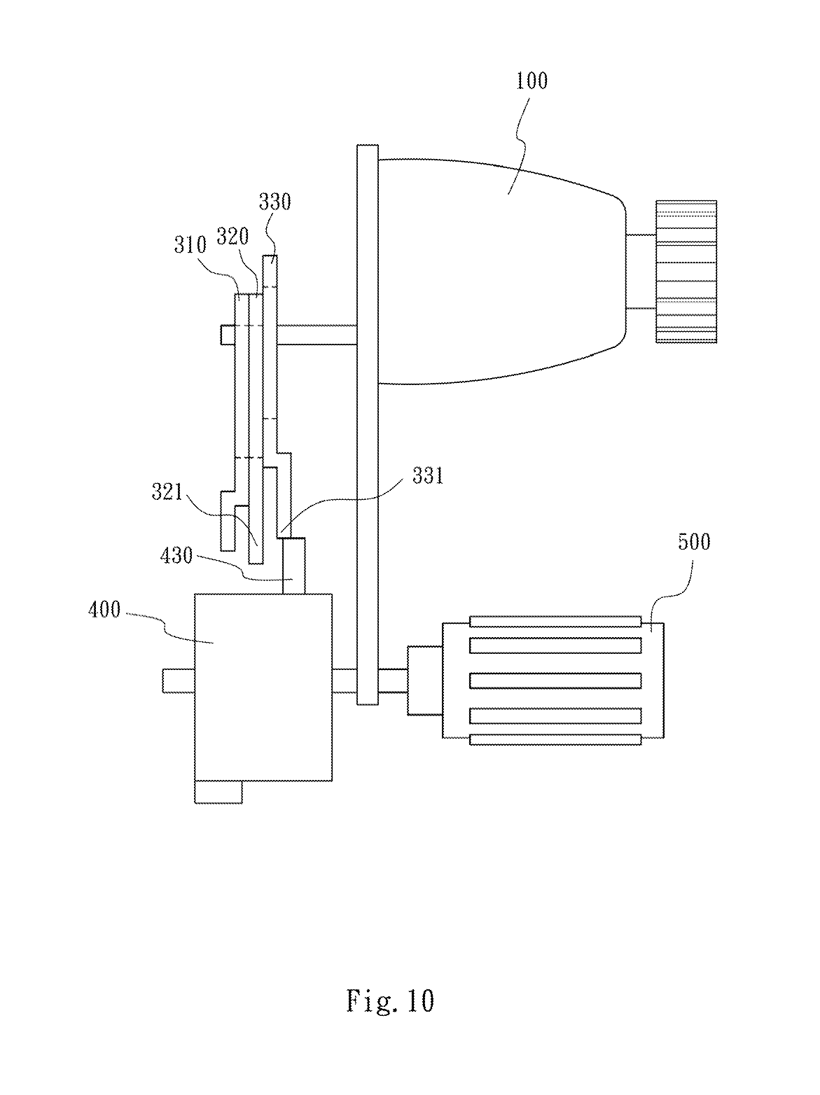

FIG. 9 is a front view of the headlamp of FIG. 1, showing that the cam 400 pushes yet another light shade 330. FIG. 10 is a side view of the headlamp of FIG. 1, showing that the cam 400 pushes yet another light shade 330. Similarly, the lobe 430 pushes the follower part 331 to move the light shade 330 for producing yet another shape of the light beam, after the lobe 420 is removed and the light shade 321 falls.

Because of the difference of the distance between the follower parts 311, 321, 331 and the lobes 410, 420, 430, the light shades 310, 320, 330 have different routes when the cam 400 pushes the light shades 310, 320, 330. In detail, the route of the light shade 330 is smallest, and the route of the light shade 310 is largest.

The term “route” means the moving distance in one direction. For instance, the light shade 310 moving upward 10 cm or the light shape 320 falling 5 cm, each of the light shades 310, 320 has one route. For instance, the light shade 330 moving upward 5 cm and falling 10 cm, the light shade 330 has two routes. The light shades 310, 320, 330 have different route because of the difference of the distance between the follower parts 311, 321, 331 and the lobes 410, 420, 430.

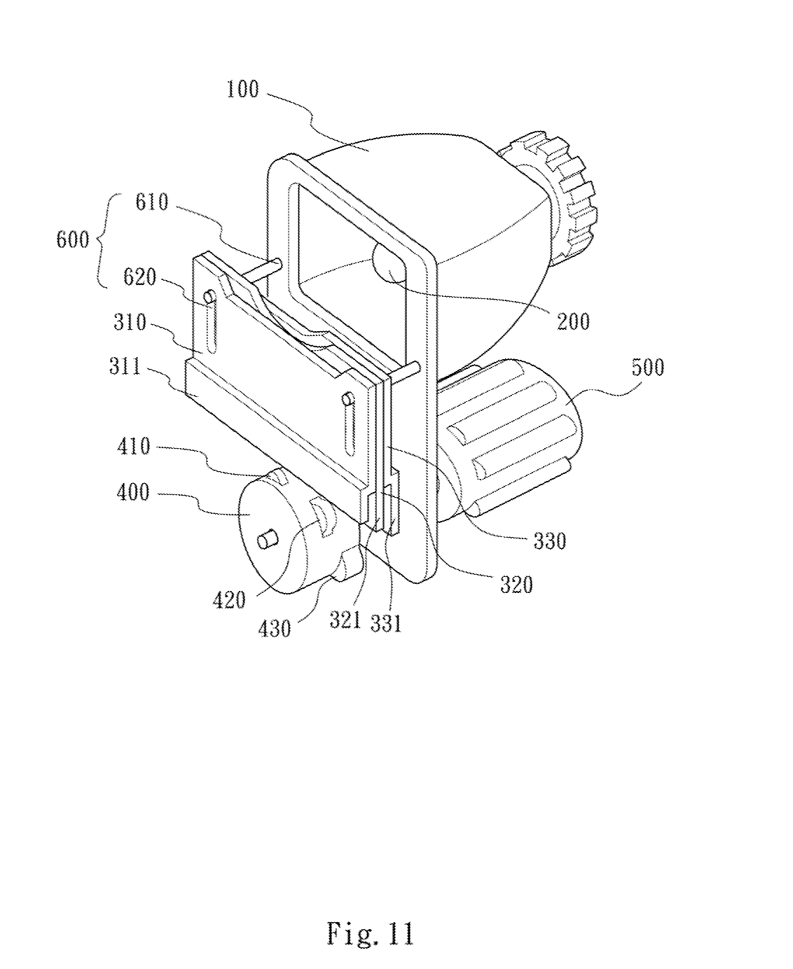

FIG. 11 is a three-dimensional view of a headlamp according to another embodiment of the present disclosure. The headlamp of FIG. 11 is substantially the same as the headlamp of FIG. 1. The difference is that the heights of the lobes 410, 420, 430 of the cam 400 are different in the headlamp of FIG. 11.

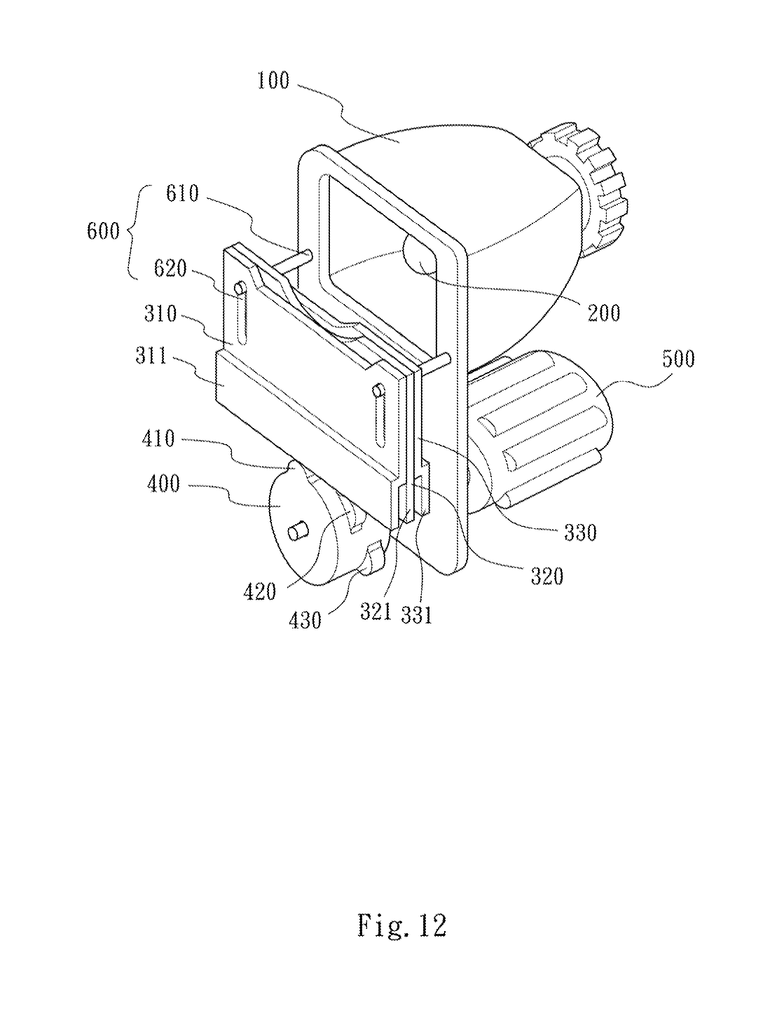

FIG. 12 is a three-dimensional view of a headlamp according to yet another embodiment of the present disclosure. The headlamp of FIG. 12 is substantially the same as the headlamp of FIG. 1. The difference is that the distance between the follower parts 311, 321, 331 and the lobes 410, 420, 430 are the same in the headlamp of FIG. 12.

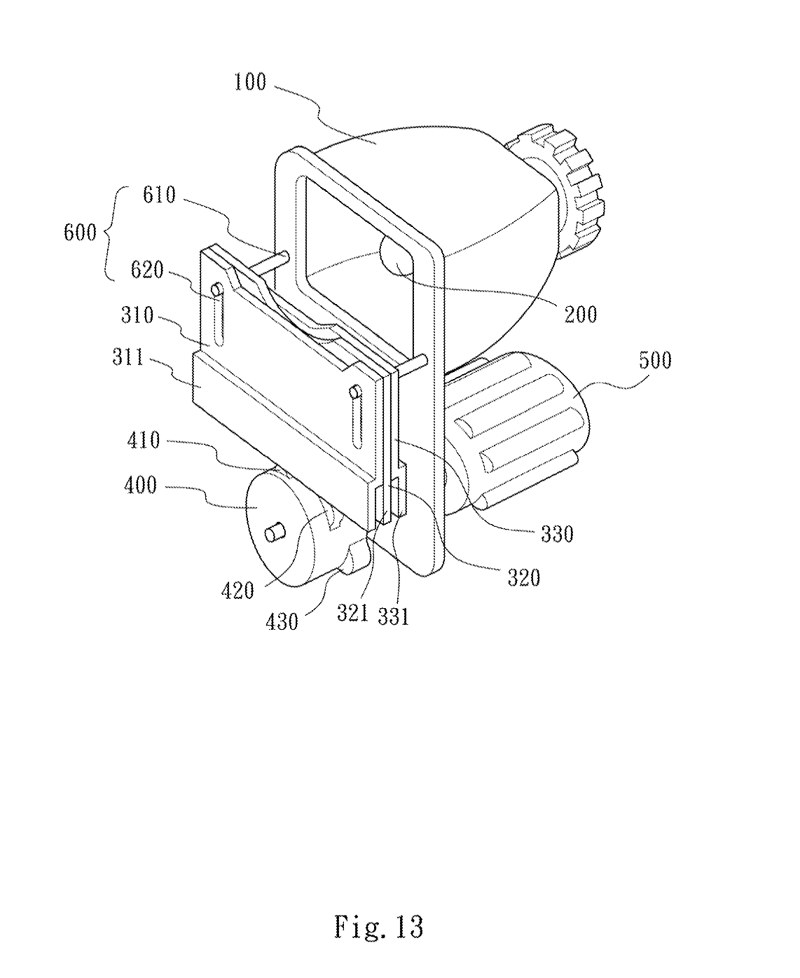

FIG. 13 is a three-dimensional view of a headlamp according to yet another embodiment of the present disclosure. The headlamp of FIG. 13 is substantially the same as the headlamp of FIG. 1. The difference is that the distance between the follower parts 311, 321, 331 and the lobes 410, 420, 430 are the same and the heights of the lobes 410, 420, 430 of the cam 400 are different in the headlamp of FIG. 13.

The three embodiments of the headlamp said in FIGS. 11, 12, and 13 have the same action and effect as the headlamp of FIG. 1. The difference is the moving distance of the light shades 310, 320, 330.

Moreover, an elastic device (not shown in figures) connects each of the light shades 310, 320, 330 and the reflector 100. The elastic device charges the restoring force when the light shade 310, 320, 330 is pushed by the lobe 410, 420, 430. The light shade 310, 320, 330 is reset by the elastic device when the lobe 410, 420, 430 is removed.

The reader's attention is directed to all papers and documents which are filed concurrently with his specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims is not intended to invoke the provisions of 35 U.S.C. §112, 6th paragraph.

What is claimed is:

1. A headlamp, comprising:
a light source for emitting at least one light beam;
a plurality of light shades;
at least one linear guide for directing the linear motions of the light shades relative to the light source; and
at least one cam for moving at least one of the light shades to shade at least one part of the light beam.

2. The headlamp of claim 1, wherein each of the light shades comprises a follower part, the cam comprises a plurality of lobes for pushing the follower parts of the light shades respectively, and the distances between the follower parts of the light shades and the lobes of the cam are different.

3. The headlamp of claim 1, wherein each of the light shades comprises a follower part, the cam comprises a plurality of lobes for pushing the follower parts of the light shades respectively, and the heights of the lobes of the cam are different.

4. The headlamp of claim 1, wherein the linear guide comprises
a plurality of grooves disposed in the light shades respectively; and
at least one pin slidably received in the grooves.

5. A headlamp, comprising:
a reflector;
a light source disposed in the reflector for emitting at least one light beam;
a plurality of light shades, each light shade comprising a follower part;
at least one linear guide moveably coupling the light shades to the reflector;
an actuator; and
a parallel indexing cam connected to the actuator, wherein the parallel indexing cam comprises a plurality of lobes for pushing at least one of the follower parts of the light shades to shade at least one part of the light beam.

6. The headlamp of claim 5, wherein lobes have different angle by axial vision, and the lobes have different position by radial vision.

7. The headlamp of claim 5, wherein the distances between the follower parts and the lobes are different.

8. The headlamp of claim 5, wherein the linear guide comprises
a plurality of grooves disposed in the light shades respectively; and
at least one pin slidably received in the grooves.
